(19) United States
(12) Patent Application Publication
(10) Pub. No.: US 2006/0049371 A1
(43) Pub. Date: Mar. 9, 2006

(54) Flexible tube flow control device and fluid feeder

(76) Inventor: Kazumasa Ohnishi, Nagaoka-shi (JP)

Correspondence Address: NIXON PEABODY, LLP, 401 9TH STREET, NW, SUITE 900, WASHINGTON, DC, 20004-2128, US

(21) Appl. No.: 10/517,486

(22) PCT Filed: Jun. 13, 2003
(86) PCT No.: PCT/JP03/07580

§ 371 Date: Dec. 10, 2004

(30) Foreign Application Priority Data
Jun. 13, 2002 (JP) 2002-207571
Jun. 20, 2002 (JP) 2002-214532
Jan. 8, 2003 (JP) 2003-34372

(51) Int. Cl. F16K 7/04

(52) U.S. Cl. 251/7

(57) ABSTRACT

A flexible tube wherein a plurality of projections formed on an inner wall of the tube to extend axially in the tube are brought into engagement with recesses defined between these projections by a pressure applied from outside to the tube, so that finally the tube interior it closed. Since the flexible tube is not required to be widthwise stretched in order to close the interior of the tube, it is superior in micro-flow controllability and durability can be used for a flow control device or fluid feeder in a desirable manner.

### FIELD OF THE INVENTION

The present invention relates to a flow control device for controlling an amount of a fluid moving within a tube, a fluid feeder for feeding a fluid within a tube, and a flexible tube which is favorably employable for the flow control device and the fluid feeder.

### BACKGROUND OF THE INVENTION

In the manufacture of foods, semiconductors, and chemical products, fluids such as water, oil, and various liquid compositions are generally employed. The flow control and feed of these liquids are generally conducted by means of flow control devices and fluid feeders.

If the fluid is highly corrosive, constitutional members of the flow control devices and fluid feeders which are kept in contact with the corrosive fluid sometimes corrode. Therefore, the flow control and feed of such corrosive fluid are conducted by means of a flow control device and a fluid feeder which are equipped with a flexible tube. The flow control and fluid feed are done utilizing elastic deformation of the flexible tube.

A flow control device equipped with a flexible tube is generally called “pinch valve”, while a fluid feeder equipped with a flexible tube is generally called “tube pump”.

The pinch valve controls an amount of a fluid flowing in the tube by pressing the tube from outside to deform the tube. The tube pump feeds a liquid within the tube by sequentially pressing or squeezing the tube in the longitudinal direction.

Since the tube of the pinch valve or tube pump only is kept into contact with the fluid, the pinch valve and tube pump are favorably employed for controlling or conducting feed of corrosive fluids or fluids which should be fed under such condition that the fluid is completely kept from contamination of foreign materials.

FIG. 1 is a section of a flexible tube which is conventionally employed for a pinch valve and a tube pump. As is understood from FIG. 1, the conventional flexible tube is a tube 11 having a circular section.

FIG. 2 is a section of a flexible tube 11 deformed after compressing the tube 11 of FIG. 1 along the arrow 20 12 shown in FIG. 1. As is seen from FIG. 2, when a flexible tube 11 having a circular section is compressed, there are sometimes produced spaces 21 and hence complete closure is not attained. These spaces 21 disturbs precise control of flowing fluid in the flow control device, and also disturbs efficiency of the feed of a fluid in the fluid feeder. Therefore, flexible tubes having various different section have been developed so as to obviate the formation of disadvantageous spaces.

Japanese Utility Model Provisional Publication 47-9015 discloses a flexible tube having a lip shape section 31 (as is illustrated in FIG. 3). Japanese Utility Model Provisional Publication 6-1944 discloses a flexible tube having a rhombus shape section 41 (as is illustrated in FIG. 4).

Flexible tubes illustrated in FIGS. 1, 3 and 4 deform to widthwise extend when they are compressed. For instance, the widthwise length (W₂ in FIG. 2) after compression of the tube having a circular section is apparently larger than the widthwise length (W₁ in FIG. 1) before compression of the corresponding tube. Since the conventionally employed flexible tubes extend in the width direction when they are compressed, they have the following problems.

The first problem resides in that the conventional flexible tube is not appropriate for precisely controlling a flow of a small amount of a fluid. In more detail, the decrease of sectional area of the tube is small in the initial stage of the compression because the tube deforms with large extension of the section in the widthwise direction, while the decrease of sectional area of the tube is large in the final stage of the compression because the tube deforms with little extension of the section in the widthwise direction. In other words, the decrease of flowing amount of a fluid is high in the final stage, and hence the desired precise control of a flowing fluid amount is difficult.

The second problem resides in that the tube deteriorates rapidly because the tube is repeatedly extended in the width direction. As is described hereinbefore, the pinch valve or tube pump are employed for controlling or feeding a corrosive fluid. It is troublesome if the tube is broken due to excessive deterioration, and the flowing corrosive fluid runs out of the tube. Therefore, the tube to be employed in the flow control device and a fluid feeder should have high physical endurance.

The present invention has an object to provide a flexible tube showing a precise controllability and good endurance so that it is favorably employable in a flow control device and a fluid feeder.

The invention has another object to provide a flow control device and a fluid feeder which are favorably employable for controlling a flow of a corrosive fluid or a fluid to be kept from contamination with foreign materials and for feeding these fluids.

### SUMMARY OF THE INVENTION

The present invention resides in a flexible tube having a plurality of projections (or protrusions) on an inner wall thereof which are extended axially in the tube under the condition that the projections are brought into engagement with recesses formed between the projections under pressure applied from outside to the tube, whereby finally closing the interior of the tube.

Preferred embodiments of the flexible tube of the invention are set forth below.

(1) Three or more projections are formed.

(2) In the flexible tube of (1) above, one or more projections are brought into further engagement in their tops with sides of other projections.

(3) In the flexible tube of (1) above, the plurality of projections comprise a pair of projections formed plane-symmetrically with respect to a plane on the axis of the tube and one projection having a symmetric plane on the plane on the axis. Further, each of the projections formed plane-symmetrically with respect to a plane on the axis of the flexible tube has at least one arched side.

(4) In the flexible tube of (1) above, the plurality of projections comprise a pair of projections formed plane-symmetrically with respect to a plane on the axis of the tube and a pair of projections having a symmetric plane perpendicular to the plane on the axis. Further, both of at least one pair of the projections are in the form of a trapezoid having arched sides.

The present invention further resides in a flow control device comprising the above-mentioned flexible tube of the invention, a restriction member restricting widthwise expansion of the tube, and a tube pressing member.

Preferred embodiments of the flow control device of the invention are set forth below.

(1) Three or more projections are formed in the flexible tube.

(2) One or more projections of the flexible tube of (1) above are brought into further engagement in their tops with sides of other projections.

(3) The plurality of projections of the flexible tube of (1) above comprise a pair of projections formed plane-symmetrically with respect to a plane on the axis of the tube and one projection having a symmetric plane on the plane on the axis, and areas on outer surface of the tube corresponding to the pair of the projections are in contact with the restriction member. Further, each of the projections formed plane-symmetrically with respect to a plane on the axis of the flexible tube has at least one arched side.

(4) The plurality of projections of the flexible tube of (1) above comprise a pair of projections formed plane-symmetrically with respect to a plane on the axis of the tube and a pair of projections having a symmetric plane perpendicular to the plane on the axis, and areas on outer surface of the tube corresponding to any one pair of the projections are in contact with the restriction member. Further, both projections of one of two pairs of the projections formed plane-symmetrically with respect to a plane on the axis of the tube, areas on outer surface of the tube corresponding to the both projections being in contact with the restriction member, are in the form of a trapezoid having arched sides.

The present invention further resides in a fluid feeder comprising the above-mentioned flexible tube of the invention, a restriction member restricting widthwise expansion of the tube, and two or more tube pressing members arranged along the axis of the tube.

Preferred embodiments of the fluid feeder of the invention are set forth below.

(1) Three or more projections are formed in the flexible tube.

(2) One or more projections of the flexible tube of (1) above are brought into further engagement in their tops with sides of other projections.

(3) The plurality of projections of the flexible tube of (1) above comprise a pair of projections formed plane-symmetrically with respect to a plane on the axis of the tube and one projection having a symmetric plane on the plane on the axis, and areas on outer surface of the tube corresponding to the pair of the projections are in contact with the restriction member. Further, each of the projections formed plane-symmetrically with respect to a plane on the axis of the flexible tube has at least one arched side.

(4) The plurality of projections of the flexible tube of (1) above comprise a pair of projections formed plane-symmetrically with respect to a plane on the axis of the tube and a pair of projections having a symmetric plane perpendicular to the plane on the axis, and areas on outer surface of the tube corresponding to any one pair of the projections are in contact with the restriction member. Further, both projections of one of two pairs of the projections formed plane-symmetrically with respect to a plane on the axis of the tube, areas on outer surface of the tube corresponding to the both projections being in contact with the restriction member, are in the form of a trapezoid having arched sides.

### BRIEF DESCRIPTION OF THE DRAWING

FIG. 1 is a section of a conventional flexible tube.

FIG. 2 is a section of the conventional flexible tube of FIG. 1 after deformation by compression.

FIG. 3 is a section of another conventional flexible tube.

FIG. 4 is a section of a further conventional flexible tube.

FIG. 5 is a partly broken view of a flow control device equipped with a flexible tube of the invention.

FIG. 6 is a section of the flow control device of FIG. 5 taken along the line I-I.

FIG. 7 is a section of the flow control device of FIG. 6, in which the flexible tube is deformed to decrease the space area by compression from outside.

FIG. 8 is a section of the flow control device of FIG. 6, in which the flexible tube is deformed to close the conduit in the tube by compression from outside.

FIG. 9 is a partly sectional view of another flow control device according to the invention.

FIG. 10 is a schematic view of a fluid feeder equipped with a flexible tube of the invention.

FIG. 11 is a partly sectional view of the fluid feeder of FIG. 10, viewed along the axis of the flexible tube.

FIG. 12 explains working mechanism of the fluid feeder of FIG. 10.

FIG. 13 is a partly broken view showing a different constitution of a fluid feeder according to the invention.

FIG. 14 is a top view of the fluid feeder of FIG. 13.

FIG. 15 is a section of another example of the flexible tube according to the invention.

FIG. 16 is a section of a further example of the flexible tube according to the invention.

FIG. 17 is a section of a still further example of the flexible tube according to the invention.

FIG. 18 is a section of a still further example of the flexible tube according to the invention.

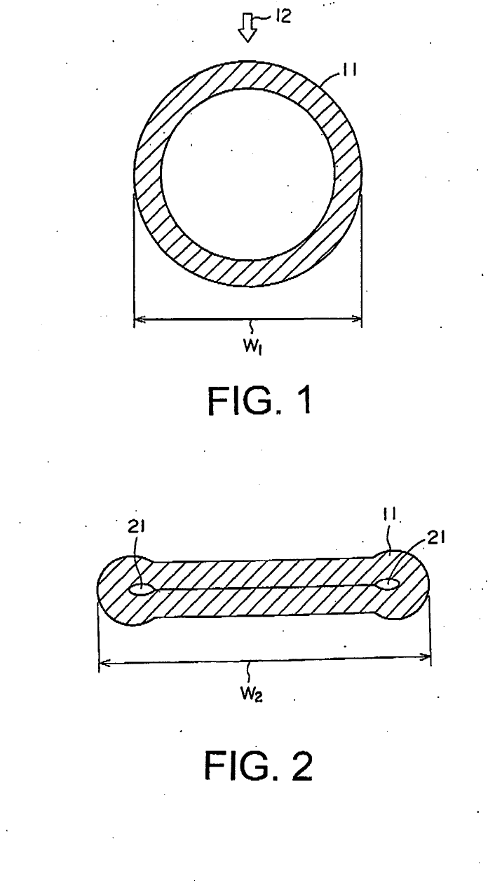

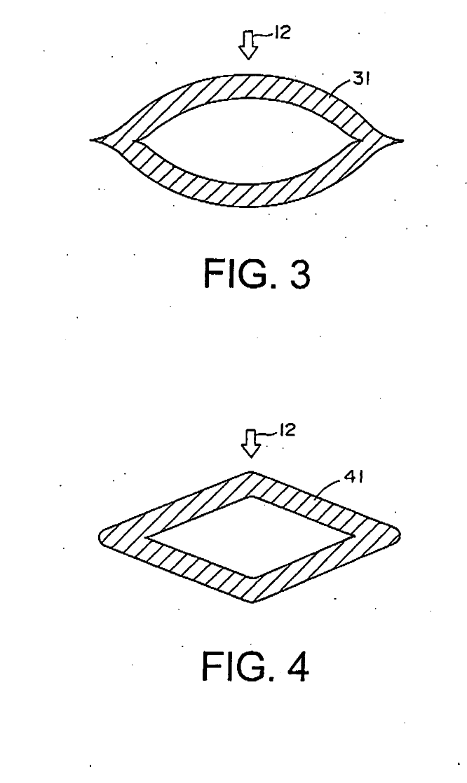

### DETAILED EXPLANATION OF THE INVENTION

The present invention is further described with reference to the attached drawings.

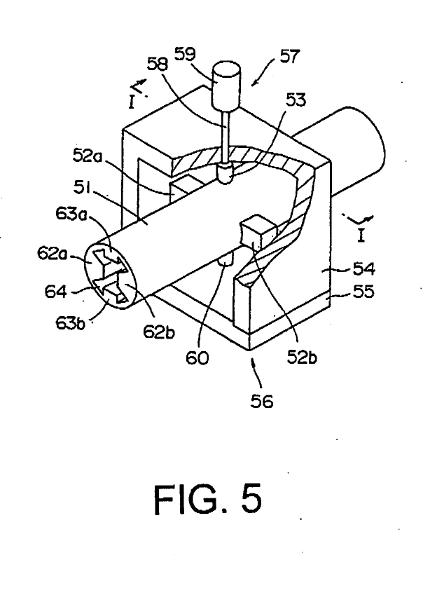

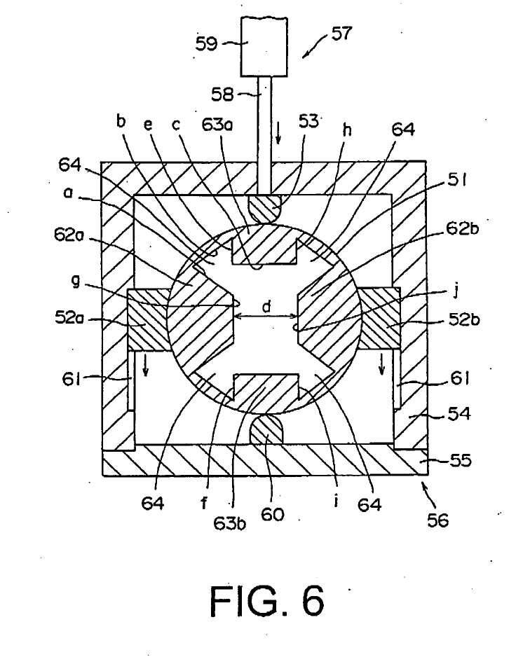

FIG. 5 is a partly broken view of a flow control device equipped with a flexible tube of the invention. FIG. 6 is a section of the flow control device of FIG. 5 taken along the line I-I.

The flow control device illustrated in FIGS. 5 and 6 comprises a flexible tube 51 of the invention, restriction members 52a, 52b restricting widthwise expansion of the tube 51, and a tube pressing member 53.

The flexible tube 51, the restriction members 52a, 52b, and the tube pressing member 53 are enclosed with a cylindrical frame 56 consisting of an upper frame 54 and a lower frame 55.

The tube pressing member 53 is fixed to a top of a driving rod 58 of a linear motor 57. A main body 59 of the linear motor 57 is fixed to the cylindrical frame 56 via a fixing member (not shown). When the linear motor 57 is driven, the tube pressing member 53 is moved downward, and the flexible tube 51 is compressed.

Each of the restriction members 52a, 52b are engaged with grooves 61 formed on the inner surface of the cylindrical frame 56, and moves downward in conjunction with the movement of the tube pressing member 53, restricting the widthwise expansion of the flexible tube 51.

It is preferred that an auxiliary pressing member 60 is arranged on the inner surface of the lower frame 55 in a position corresponding to the tube pressing member 53, so that the flexible tube 51 is compressed under such condition that the symmetric form is maintained and complete closure is attained.

The working mechanism of the flow control device shown in FIGS. 5 and 6, that is, a mechanism of closing the interior of the tube 51 by the pressure applied from outside to the flexible tube by the tube pressing member 53, is further described.

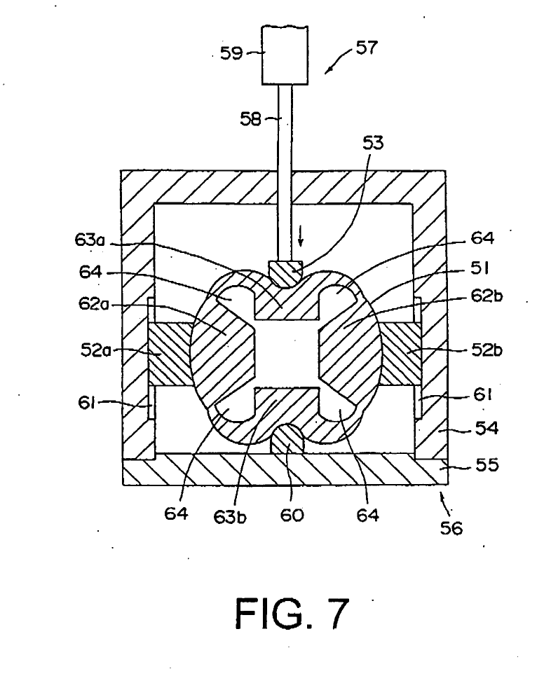

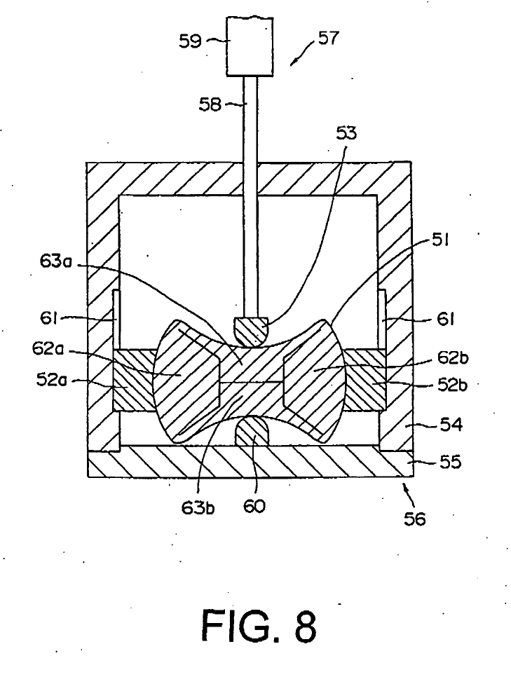

FIG. 7 is a section of the flow control device of FIG. 6, in which the flexible tube 51 is deformed to decrease the space area by compression from outside. As is seen from FIG. 7, the conduit of the tube is made narrow by the pressure applied to the flexible tube 51 from outside, so that the amount of the fluid flow can be controlled.

FIG. 8 is a section of the flow control device of FIG. 6, in which the flexible tube 51 is deformed to close the conduit in the tube by compression from outside. As is seen from FIG. 8, the conduit of the tube is completely closed by the pressure applied to the flexible tube 51 from outside.

As is seen from FIGS. 6, 7 and 8, the flexible tube of the invention does not expand to the widthwise direction because the closure can be attained by the engagement of the projections and recesses between the projections. Thus, the desired precise control of the fluid flow can be attained by adequately designing the recesses between the projection 63a and the projection 63b. In addition, the flexible tube of the invention shows a high endurance because it closes the interior space not by widthwise expansion.

The flexible tube of the invention is further described below.

The flexible tube of the invention is characteristic in having a plurality of projections on an inner wall thereof which are extended axially in the tube under the condition that the projections are brought into engagement with recesses formed between the projections under pressure applied from outside to the tube, whereby finally closing the interior of the tube.

The constitution of the tube and the engagement between the projections and recesses are described by referring to the flexible tube of the flow control device of FIG. 6.

On the inner wall surface of the flexible tube 51 of the flow control device of FIG. 6 are formed four projections. The four projections are constituted of a pair of projections 62a, 62b formed plane-symmetrically with respect to a plane (i.e., vertical plane in FIG. 6) on the axis of the tube and a pair of projections 63a, 63b having a symmetric plane (i.e., horizontal plane) perpendicular to the plane on the axis. The areas of outer surface of the tube corresponding to the projections 62a, 62b are placed in contact with the restriction members 52a, 52b of the flow control device.

The four projections of the flexible tube 51 are so formed that they can be engaged with the four recesses formed between the projections by the pressure applied from outside to the tube and finally can close the interior of the tube, as is shown in FIG. 8. Further, the four projections of the flexible tube 51 are so formed that tops of the two projections 63a, 63b can be engaged with the sides of the projections 62a, 62b by the pressure applied to the tube and finally can close the interior of the tube.

In order to attain the above-mentioned engagements, the flexible tube 51 of FIG. 6 is so designed as to have a section satisfying the following conditions:

(1) The length (in the section) of each of the sides of the projections 62a, 62b is equal to each of the length of the bottom of the recesses adjoining the projections. For instance, the length “a” of the side of the projection 62a is equal to the length “b” of the bottom of the recess adjoining the projection. Under the condition, the projections 63a, 63b come into the space formed between the projection 62a and the projection 62b.

(2) The length (in the section) of each of the tops of the projections 63a, 63b is equal to the length of the space between the projection 62a and the projection 62b.

For instance, the length “c” of the top of the projection 63a is equal to the space “d” between the projection 62a and the projection 62b. Under the condition, no space remains in the tube when the tube is closed.

(3) The total of the length “e” and length “f” of the sides of the projection 63a and the projection 63b, respectively, are equal to the length “g” of the top of the projection 62a, and the total of the length “h” and length “i” of the sides of the projection 63a and the projection 63b, respectively, are equal to the length “j” of the top of the projection 62b. Under the condition, no space remains in the tube when the tube is closed.

If the interior of the tube is not completely closed when the flexible tube is pressed, the flexible tube is further compressed to deform its shape to completely close its interior. In view of this closing mechanism, the above-mentioned condition of “equal” includes “essentially equal”. The “essentially” means that difference between one length and another length is set within ±40%, preferably ±20%, more preferably ±10%.

The flexible tube of the invention can comprise the same flexible material as that employed for the manufacture of the known pinch valve and tube pump. Examples of the flexible materials include fluororesin such as PFA (tetrafluoroethylene-perfluoroalkylvinylether copolymer), polypropylene resin, and silicone rubber.

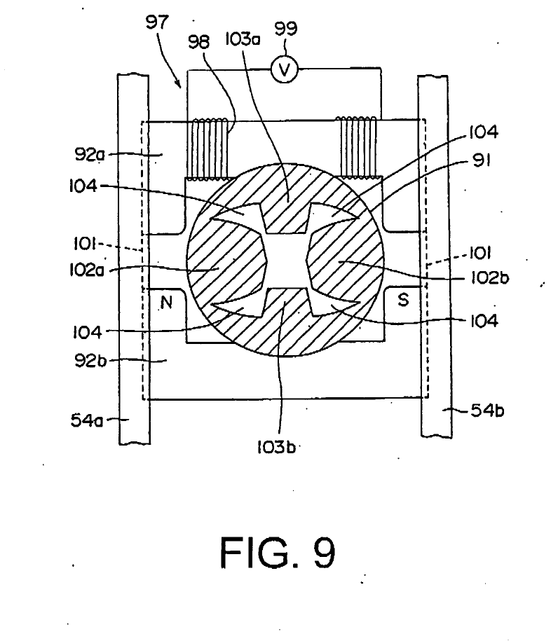

FIG. 9 is a partly sectional view of another flow control device according to the invention.

The flow control device of FIG. 9 comprises a flexible tube 91 of the invention, restriction members 92a, 92b which restrict widthwise expansion or extension of the tube 91, and a tube pressing member (the restriction member 92a serves as the pressing member). As is illustrated in FIG. 9, the restriction member and the tube pressing member can be united.

Each of the restriction members 92a, 92b is engaged with a groove 101 formed in each inner side of the frames 54a, 54b. The restriction member 92a is made, for instance, of material of high magnetic permeability such as Permalloy. The restriction member 92a has a coiled copper wire 98 and the copper wire 98 is electrically connected to an electric source 99. A combination of the restriction member 92a, copper wire 98, and the electric source 99 forms an electromagnet 97. The restriction member 92b is a magnet. Each of the symbols of “N” and “S” shown in FIG. 9 indicates the polarity of the magnet.

When the electromagnetic 97 receives electric energy form the electric source 99, the restriction members 92a, 92b attract each other so that the restriction member 92a comes down and the restriction member 92b comes up. Thus, the flexible tube is compressed under the restriction of widthwise expansion by the restriction members 92a, 92b.

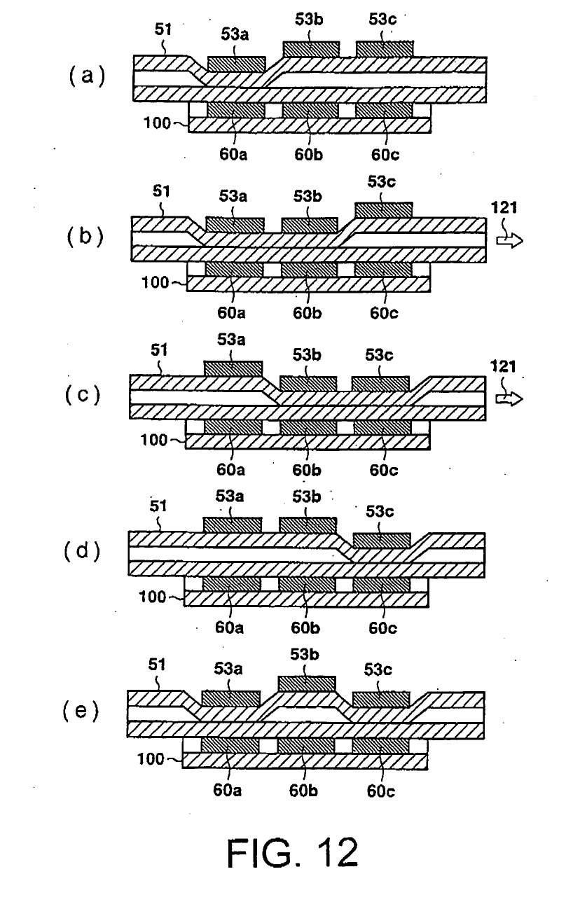

The flexible tube 91 has four projections on the inner wall. The four projections consists of a pair of projections 102a, 102b formed plane-symmetrically with respect to a plane (vertical plane in FIG. 9) on the axis of the tube 91, and a pair of projections 103a, 103b a copper wire coiled around the core member, and an electric source electrically connected with the copper wire. Each electromagnet is fixed to the restriction member 100 via a fixing means (not shown). On the bottom of the restriction member 100 are provided auxiliary restriction members (60a, 60b, 60c in the section of the fluid feeder of FIG. 12) in the positions facing the tube-pressing members 53a, 53b, 53c.

When each of the electromagnets a, b, c receives electric energy from the electric source, each of the tube-pressing members 53a, 53b, 53c move downward, respectively. The movement of the tube-pressing member closes the interior of the tube in the position corresponding to the tube-pressing member.

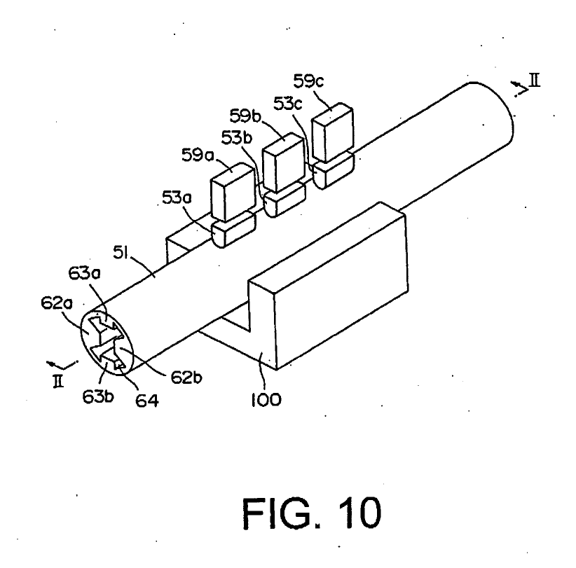

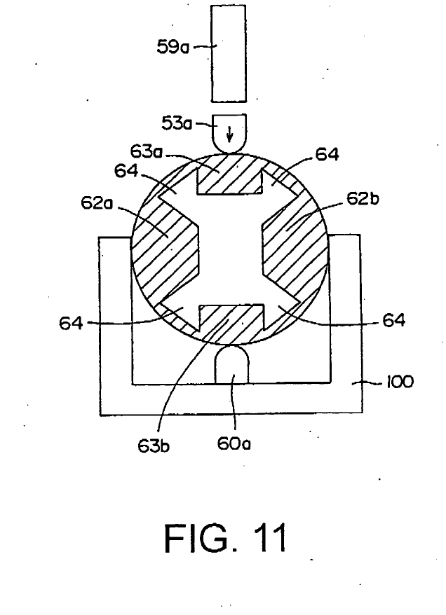

The fluid feeder shown in FIGS. 10 and 11 works in the manner described below.

FIG. 12 explains working mechanism of the fluid feeder of FIG. 10. FIG. 12 is illustrated to show a section of the fluid feeder of FIG. 10 taken along the line II-II. The electromagnets 59a, 59b, c of the fluid feeder are not shown in FIG. 12.

First, the tube-pressing member 53a works to close the interior of the tube, as is shown in (a). Subsequently, the tube-pressing members 53b, 53c work sequentially to close the interior of the tube, as are shown in (b) and (c), so that the fluid in the interior of the tube is sent in the direction indicated by an arrow 121. When the pressing procedures by the tube-pressing members 53a, 53b are sequentially terminated, the fluid is introduced into the interior of the tube, as is shown having a symmetric plane (horizontal plane in FIG. 9) perpendicular to the plane on the axis.

Each of a pair of the projections 102a, 102b is in the form of a trapezoid having arched sides. The flexible tube 91 is formed to satisfy the conditions of the above-mentioned (1) to (3).

As is shown in FIG. 9, the four projections of the flexible tube are preferably formed under the condition that the each of corners of the projections 103a, 103b is not brought into contact with each of corners of the projections 102a, 102b when the projections 103a, 103b move by the pressure from outside. Under the condition, each of the projections 103a, 103b smoothly comes into the space between the projection 102a and projection 102b.

FIG. 10 is a schematic view of a fluid feeder equipped with a flexible tube of the invention. FIG. 11 is a partly sectional view of the fluid feeder of FIG. 10, viewed along the axis of the flexible tube 51.

The fluid feeder of FIGS. 10 and 11 comprises a flexible tube 51 of the invention, a restriction member 100 which restricts widthwise expansion of the tube 51, and three tube-pressing members 53a, 53b, 53c which are arranged on the tube along the axis of the tube. The constitution of the flexible tube 51 is the same as that employed in the fluid control device of FIG. 5.

Each of the tube-pressing members 53a, 53b, 53c comprises electromagnetic material. The tops of the tube-pressing members are attached to electro-magnets a, b, c. Each electromagnet comprises a core member made of high magnetic permeability material such as Permalloy, in (c) and (d). Then, the tube-pressing means 53a works again close the interior of the tube. These procedures are repeated to send the fluid in the interior of the flexible tube 51 in the direction indicated by the arrow 121.

As is seen from FIG. 12, the flexible tube 51 of the fluid feeder is repeatedly deformed by the sequential pressing. Nevertheless, since the flexible tube of the fluid feeder of the invention shows high endurance because there is no need of widthwise extending the tube for closing the interior of the tube.

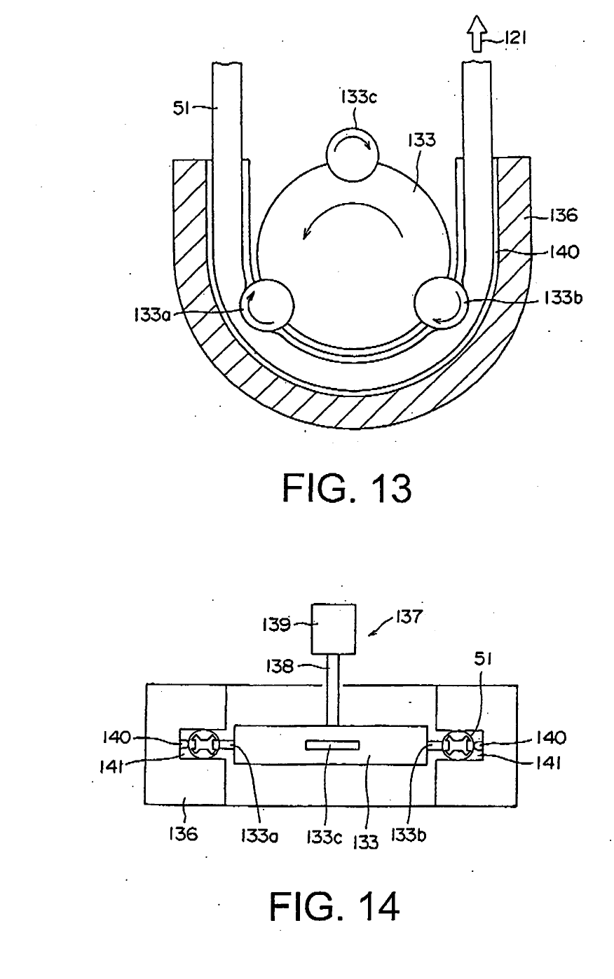

FIG. 13 is a partly broken view showing a different constitution of a fluid feeder according to the invention. FIG. 14 is a top view of the fluid feeder of FIG. 13.

The fluid feeder shown in FIGS. 13 and 14 comprises a flexible tube 51 of the invention, a restriction member 136 restricting widthwise expansion of the tube 51, and two tube-pressing members 133a, 133b placed along the axis of the tube. The tube-pressing members 133a, 133b as well as a tube-pressing member 133c are arranged on the periphery of a disc 133 rotatable by action of a motor 137. When the disc 133 rotates, the tube-pressing members 133a, 133b, 133c work to sequentially close the interior of the tube in the longitudinal direction of the tube. Then, the fluid in the interior of the tube is sent in the direction indicated by an arrow 121 in FIG. 13. According to the fluid feeder of the invention, the flexible tube is not extent widthwise to close the tube, and hence high endurance is attained.

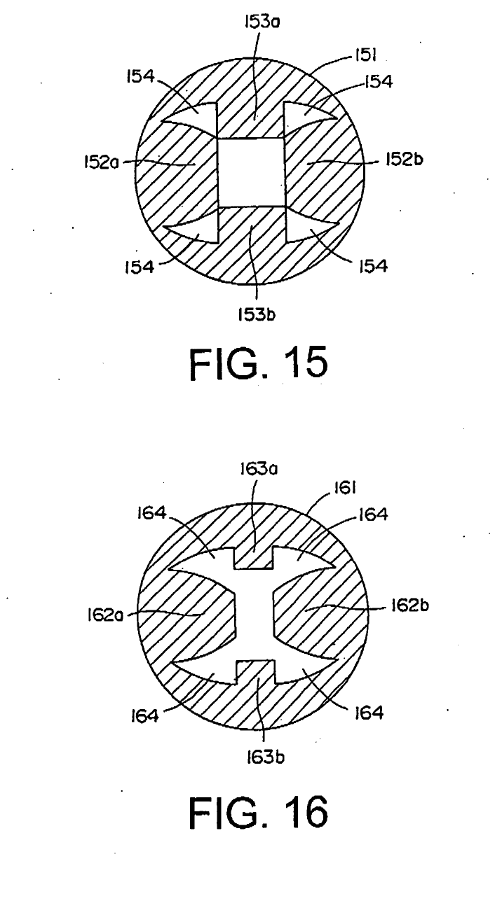

FIG. 15 is a section of another flexible tube according to the invention. As is seen from FIG. 15, the projections 153a, 153b of the flexible tube 151 can be so formed that the these tops are placed between the projection 152a and projection 152b. This constitution is effective to smoothly introduce the projections 153a, 153b into a space between the projection 152a and projection 152b.

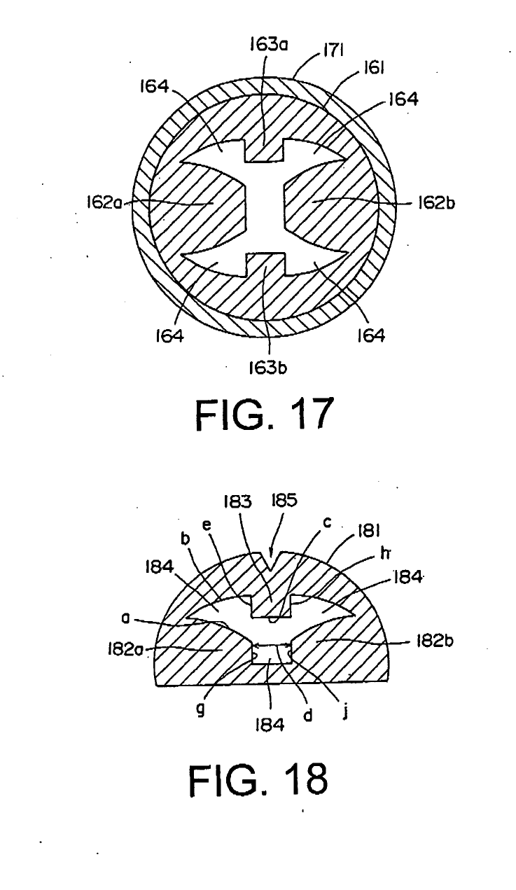

FIG. 16 is a section of a further example of the flexible tube according to the invention. The flexible tube 161 of FIG. 16 has a long space between the projection 163a and projection 163b. Accordingly, the tube enables to send a relatively large amount of a fluid. The flexible tube 161 can be covered with another flexible tube 171 as is shown in FIG. 17. The covering tube 171 can obviate running-out of the fluid when the flexible tube 161 is broken.

FIG. 18 is a section of a still further example of the flexible tube according to the invention.

The flexible tube 181 of FIG. 18 has three projections on the inner wall. The three projections consists of a pair of projections 182a, 182b formed plane-symmetrically with respect to a plane (vertical plane in FIG. 18) on the axis of the tube and one projection 183 having a symmetric plane on the plane on the axis. Each of the projections 182a, 182b has an arched face on one side.

The three projections of the flexible tube 181 are so designed that the three projections can be engaged with three recesses 184 formed between the projections under pressure applied to the tube from outside and finally the interior of the tube can be closed. In addition, the three projections of the flexible tube 181 are so formed that the top of the projection 183 can be engaged with sides of other projections, i.e., the projections 182a, 182b, and finally the closure of the interior of the tube is completed.

In order to attain the above-mentioned engagements, the flexible tube 181 of FIG. 18 is so designed as to have a section satisfying the following conditions:

(1) The length (in the section) of each of the sides of the projections 182a, 182b is equal to each of the length of the bottom of the recesses adjoining the projections. For instance, the length “a” of the side of the projection 182a is equal to the length “b” of the bottom of the recess adjoining the projection. Under the condition, the projection 183 comes into the recess formed between the projection 182a and the projection 182b.

(2) The length “c” (in the section) of the top of the projection 183 is equal to the space “d” between the projection 182a and the projection 182b. Under the condition, no space remains in the tube when the tube is closed.

(3) The length “e” (in the section) of the side of projection 183 is equal to the length “g” of the top of the projection 182a, and the length “h” (in the section) of the side of projection 183 is equal to the length “j” of the top of the projection 182b. Under the condition, no space remains in the tube when the tube is closed.

There is formed a groove 185 on the top of the flexible tube 181. The groove 185 is effective to relax stress produced in the tube when the tube is compressed. Accordingly, the endurance of the flexible tube is enhanced.

### Utilization in Industrial Field

The flexible tube of the invention is characterized in that plural projections are so formed on the inner wall that these projections can be engaged with recesses formed between these projections by pressure applied to the tube from outside and finally the interior of the tube can be closed. There is no need of widthwise extending the tube for the purpose of closing the interior of the tube. Accordingly, the flexible tube of the invention enables to precisely control the flow of fluid and shows increased endurance, and hence is favorably employable for a flow control device and a fluid feeder.

What is claimed is:

1. A flexible tube having a plurality of projections on an inner wall thereof which are extended axially in the tube under the condition that the projections are brought into engagement with recesses formed between the projections under pressure applied from outside to the tube, whereby finally closing the interior of the tube.

2. The flexible tube of claim 1, wherein three or more projections are formed.

3. The flexible tube of claim 2, wherein one or more projections are brought into further engagement in their tops with sides of other projections.

4. The flexible tube of claim 2, wherein the plurality of projections comprise a pair of projections formed plane-symmetrically with respect to a plane on the axis of the tube and one projection having a symmetric plane on the plane on the axis.

5. The flexible tube of claim 4, wherein each of the projections formed plane-symmetrically with respect to a plane on the axis of the tube has at least one arched side.

6. The flexible tube of claim 2, wherein the plurality of projections comprise a pair of projections formed plane-symmetrically with respect to a plane on the axis of the tube and a pair of projections having a symmetric plane perpendicular to the plane on the axis.

7. The flexible tube of claim 6, wherein both of at least one pair of the projections are in the form of a trapezoid having arched sides.

8. A flow control device comprising a flexible tube having a plurality of projections on an inner wall thereof which are extended axially in the tube under the condition that the projections are brought into engagement with recesses formed between the projections under pressure applied from outside to the tube, whereby finally closing the interior of the tube, a restriction member restricting widthwise expansion of the tube, and a tube pressing member.

9. The flow control device of claim 8, wherein three or more projections are formed in the flexible tube.

10. The flow control device of claim 9, wherein one or more projections of the flexible tube are brought into further engagement in their tops with sides of other projections.

11. The flow control device of claim 9, wherein the plurality of projections of the flexible tube comprise a pair of projections formed plane-symmetrically with respect to a plane on the axis of the tube and one projection having a symmetric plane on the plane on the axis, and areas on outer surface of the tube corresponding to the pair of the projections are arranged in contact with the restriction member.

12. The flow control device of claim 11, wherein each of the projections formed plane-symmetrically with respect to a plane on the axis of the flexible tube has at least one arched side.

13. The flow control device of claim 9, wherein the plurality of projections of the flexible tube comprise a pair of projections formed plane-symmetrically with respect to a plane on the axis of the tube and a pair of projections having a symmetric plane perpendicular to the plane on the axis, and areas on outer surface of the tube corresponding to any one pair of the projections are in contact with the restriction member.

14. The flow control device of claim 13, wherein both projections of one of two pairs of the projections formed plane-symmetrically with respect to a plane on the axis of the tube, areas on outer surface of the tube corresponding to the both projections being in contact with the restriction member, are in the form of a trapezoid having arched sides.

15. A fluid feeder comprising a flexible tube having a plurality of projections on an inner wall thereof which are extended axially in the tube under the condition that the projections are brought into engagement with recesses formed between the projections under pressure applied from outside to the tube, whereby finally closing the interior of the tube, a restriction member restricting widthwise expansion of the tube, and two or more tube pressing members arranged along the axis of the tube.

16. The fluid feeder of claim 15, wherein three or more projections are formed in the flexible tube.

17. The fluid feeder of claim 15, wherein one or more projections of the flexible tube are brought into further engagement in their tops with sides of other projections.

18. The fluid feeder of claim 16, wherein the plurality of projections of the flexible tube comprise a pair of projections formed plane-symmetrically with respect to a plane on the axis of the tube and one projection having a symmetric plane on the plane on the axis, and areas on outer surface of the tube corresponding to the pair of the projections are arranged in contact with the restriction member.

19. The fluid feeder of claim 18, wherein each of the projections formed plane-symmetrically with respect to a plane on the axis of the flexible tube has at least one arched side.

20. The fluid feeder of claim 16, wherein the plurality of projections of the flexible tube comprise a pair of projections formed plane-symmetrically with respect to a plane on the axis of the tube and a pair of projections having a symmetric plane perpendicular to the plane on the axis, and areas on outer surface of the tube corresponding to any one pair of the projections are in contact with the restriction member.

21. The fluid feeder of claim 20, wherein both projections of one of two pairs of the projections formed plane-symmetrically with respect to a plane on the axis of the tube, areas on outer surface of the tube corresponding to the both projections being in contact with the restriction member, are in the form of a trapezoid having arched sides.
